(19) United States
(12) Patent Application Publication
(10) Pub. No.: US 2006/0059167 A1
(43) Pub. Date: Mar. 16, 2006

(54) Management of data described with an extensible markup language

(76) Inventors: Marcus Burgel, Heroldsberg (DE); Egard Frank, Nurnberg (DE); Rainer Heller, Eckental (DE); Heinrich Kulzer, Nurnberg (DE); Dieter Wibmann, Pinzberg (DE)

Correspondence Address: Siemens Corporation;Intellectual Property Department, 170 Wood Avenue South, Iselin, NJ, 08830, US

(21) Appl. No.: 10/532,733

(22) PCT Filed: Oct. 17, 2003
(86) PCT No.: PCT/DE03/03451

§ 371 Date: Apr. 26, 2005

(30) Foreign Application Priority Data
Oct. 30, 2002 (DE) 102 50 639.6

(51) Int. Cl. G06F 7/00

(52) U.S. Cl. 707/100

(57) ABSTRACT

The invention relates to a system and a method for simplified management of data described with an extensible markup language, wherein the data is structured in the form of objects, wherein components of the objects can be stored in first data files. The components represent a logical unit of an object, wherein a second data file having first means for referencing the components is provided as higher, object-based logical level for storing the objects.

### CROSS REFERENCE TO RELATED APPLICATIONS

This application is the US National Stage of International Application No. PCT/DE2003/003451, filed Oct. 17, 2003 and claims the benefit thereof. The International Application claims the benefits of German application No. 10250639.6 filed Oct. 30, 2002, both applications are incorporated by reference herein in their entirety.

### FIELD OF THE INVENTION

The invention relates to a method and a system for managing data described by means of an extensible markup language.

### SUMMARY OF THE INVENTION

Data is often described by means of an extensible markup language. XML (=Extensible Markup Language) is an instance of a markup language of this type. This text-based format is used both as an exchange format and as a storage format. A disadvantage of this format is that the volume of data can very quickly become very copious as a result of this filing format. Objects (such as objects from the automation world) are often filed in the data file. The expenditure demands can be very high if these objects have to be read in again, especially if an application is interested only in a subset of the objects or, as the case may be, only a part of the data. The entire file must nonetheless always be read and processed sequentially because with extensible markup languages data is filed in files and processed in a stream-oriented manner.

The object of the invention is to simplify the management of data described by means of an extensible markup language.

Said object is achieved by means of a method for managing data described by means of an extensible markup language wherein said data is structured in the form of objects, wherein components of said objects can be stored in first files, wherein said components each represent a logical unit of an object, and wherein a second file having first means for referencing said components is provided as a higher-order, object-based logical level for storing said objects.

Said object is achieved by means of a system for managing data described by means of an extensible markup language wherein objects for structuring the data are provided, wherein components of said objects can be stored in first files, wherein said components each represent a logical unit of an object, and wherein a second file having first means for referencing said components is provided as a higher-order, object-based logical level for storing said objects.

Object complexes are often filed in one large file or are distributed among a plurality of small files. Correlations between objects are either specified by means of the file structure or are indicated by means of links cross-referencing the files and objects situated therein. The invention proposes a method and a system making it possible to distribute the filing of objects and object complexes among a plurality of files and at the same time optimizing access to the object complex. The number of files to be read, and hence the volume of data having to be read, is reduced. The basis of this is that a further, logical level for objects is defined above the level having data described in a pure markup language. That is to say a method or, as the case may be, system for representing objects with their data in the markup language. Applications that read the data do not have to read the entire object complex and its data but can instead use the logical object level in order to read only as far as the granularity which they need for the work they are performing on the object complex. Tools not requiring certain parts of the object complex can thus very easily read past the relevant places since the data or, as the case may be, information is filed in separate relocation files. Said parts do not have to be read or processed by the markup language parser. Parts (referred to below also as features) of an object can be relocated to first files. One or more relocated object parts are filed in the respective first file. The object will in this case remain in the source file. Only one or more features of the object will be relocated. This makes it possible to navigate to the object within the source file as far as the relocated object part (feature). The object parts moreover continue to be moveable without the need to change references thereto.

According to an advantageous embodiment of the invention the relocated components are themselves objects. In each case only an object stub remains in the second file, referred to also as the source file, in the form of a relocation reference. This ensures that references to the relocated object do not differ from other object references referencing objects or object parts in the source file. It does not have to be known at the source of the reference that the target object is a relocated object. The relocated object is filed in its entirety in the respective first file, referred to also as the relocation file. An object can therefore be moved without the need to change references to the object. The possibility of navigating to the object within the source file or, as the case may be, from outside is also provided.

The components, called features, of the objects are advantageously stored in object-specific generic containers, with said containers serving to reference the respective object. In the relocation file the features are thus filed in a container, referred to below also as a deputizing object or ObjectSurrogate. Said deputizing object generically represents a wrapper for the object's data and forms the context for filing the features. The context is the identification of the object as identified in the source file. There is thus in the relocation file a deputizing object describing to which object in the source file the data belongs. The deputizing object is an object type representing a generic object and capable of accommodating any features. The object's data is not alone in the relocation file but, through the deputizing object, has a reference to the actual object in the source file and thus makes a back-reference available.

The invention is described and explained in more detail below with the aid of the figures shown in the exemplary embodiments.

### BRIEF DESCRIPTION OF THE DRAWINGS

FIG. 1 shows a schematic of an object's relocation to a relocation file, and

FIG. 2 shows a schematic of the relocation of a part of an object to a relocation file.

### DETAILED DESCRIPTION OF THE INVENTION

XML is used in the exemplary embodiments as an instance of an expandable markup language. Data in XML files is read sequentially and non-required parts of the file are passed over. The XML syntax is very helpful here, allowing data always to be provided with a start and end tag having the same name (for example <DisplayName>) or, as the case may be, the tag to be closed again immediately (for example <Text . . . />)

### EXAMPLE

<DisplayName>
<Text Value=“DP-Master” />
</DisplayName>

The reading-in tool (referred to as a “parser”) is thus able to pass over data beginning from a certain start tag up to the associated end tag. The content of the file between the tags will nonetheless still have to be read even if the data is not processed. A method for distributing data inventories among a plurality of files is offered by the XML Inclusions (XInclude) construct proposed by the W3C Consortium. This belongs to the basic definitions of XML currently being drafted by W3C (=World Wide Web Consortium). XInclude functions as a simple mechanism for incorporating XML or text files in an XML document. This is done analogously to the #include known from C/C++ as a textual substitution of the Xinclude tag by the other document. Either the entire document or only parts thereof (specified by an XPointer, see XML specification) can here be embedded. This does not, however, resolve the problem of passing over object parts not required since XML parsers automatically also add the referenced files during reading. The volume of data to be handled remains the same. The same as described above applies when parts of the file of no interest are passed over. The problem here is that XML per se only represents data and is unaware of an object model. Data logically correlated in objects cannot therefore be detected at XML level. A further possibility that is customary today is to distribute large data files among a plurality of small files, with its being typical to proceed such that the boundary between files also always forms the logical object boundary. Objects of the application level are thus filed in one file. The reference between objects is indicated by means of a link to the file. The information about the object in the target file is therefore absent in the source file; there is typically only the information that one or more objects are filed there.

Said data can be filed in a manner distributed among a plurality of files so as to optimize the handling of large XML data volumes including objects among their data. An XML schema is defined for this for filing objects and their components. A further, object-based logical level is thus introduced above the level of the pure XML. Objects or, as the case may be, parts of objects can at said further level be distributed among a plurality of files. It is here no longer necessary to file all objects in one overall file; objects can instead be filed in such a way that the core information necessary for identifying the object and its type is present in a source file. The object's actual (usually copious) useful information is, however, relocated to a relocation file. Data of one or more objects can be filed therein. Beneficial use is here made of the fact that objects consist usually of different “types of data”. It can therefore be differentiated according to
data which describes the object per se (object identification, name, etc.),
data which is of general interest and hence of interest to different applications or, as the case may be, parts of applications, and
data which is highly specific and only of interest to a specific application or, as the case may be, a partial application.

This can be exploited to split an object into logical components and to file these, where applicable optimized in keeping with the main uses, in different files. Tools that do not require specific parts of the object complex can thus very easily pass over the relevant places because the information is filed in separate relocation files. Said parts do not have to be read in or processed by the XML parser. An object's data is accordingly split into different components forming logical units and representing specific aspects on an object. Grouping is based on the logical co-association of the object's components with a specific “view” (for example HMI, hardware, software) of the object. Said components are referred to below also as features. They group the object's parameters, references, etc. A logical object model and a mechanism for splitting object data are therefore defined above the syntactical level of pure XML that permit object complexes to be filed in hierarchically structured files and the data of objects to be distributed among a plurality of files which meet the different requirements for the accessing of data, which is to say support the most important UseCases for using the data.

The basic notions underlying this are:
The data requiring to be filed in XML is modeled as objects and can be described by way of an XML schema. It is hereby possible to define semantics for relocating objects, with its being of practical advantage here for all object types in the XML schema to be derived from one basic object type. This is not absolutely essential, however.
A mechanism is specified determining how objects or, as the case may be, object complexes can be distributed among a plurality of files.
Splitting between files takes place at locations where a Part Of relationship exists in the object model. The assumption here is that if an object consists of further subobjects, said subobjects will typically be candidates for relocation. Applications or, as the case may be, parts of applications frequently access objects at a different granularity level. In one application it is only of interest, say, to know what an object is, said object's subobjects being of no interest unless the object is processed (in an editor, for example). Only then will this partial data be accessed.
A stub object remains in the source file in the form of a relocation reference. This ensures that references to the relocated object do not differ from other object references. It does not have to be known at the source of the reference that the target object is a relocated object. The relocated object is filed in its entirety in the relocation file. This has the following advantages:
   References to relocated objects do not have to differ from references to non-relocated objects.
   An object can be moved without the need to change references to the object.
   There is the possibility of navigating to the object within the source file or, as the case may be, from outside.
It is also possible to relocate parts of an object (features) to a file. The object will in this case remain in the source file. Only one or more features of the object will be relocated. In the relocation file the features will be filed in an ObjectSurrogate. This deputizing object generically represents a wrapper for the object's data and forms the context for filing the features. The context is the identification of the object as identified in the source file. This has the following advantages:
   In the relocation file there is a deputy describing to which object the data belongs.
   The deputy is an object type representing a generic object and capable of accommodating any features.
   There is the possibility of navigating to the object within the source file as far as the relocated object part (feature).
   The object part can be moved without having to change references thereto (the object contains stub information about the relocated object part).
   The object's data is not alone in the relocation file but, through the deputizing object, has a reference to the actual object in the source file (a type of back-reference).

The references to relocated objects contain various data (as XML attributes or, where applicable, also as XML elements):
The object's identification data (for example the object ID, object name, etc.).
The target file in which the object is located (for example the name of the file and its path).
The object's identification data in the target file (for example the object ID, object name).

This structure of the reference allows the addressing of the object in the relocation file to be changed independently of the object's identification. Rules governing where to split objects or, as the case may be, object complexes filed in XML files are to be defined specifically for the particular application and converted into a corresponding XML schema.

An example of the invention's use is the exporting of data from one application so said data can be further processed in other applications. Objects are structured in one application in trees (with cross-referencing through references to any objects). The relocating of objects to other files takes place only at partial tree boundaries. All objects and features at the top logical level of a relocated file will thus belong to the same object/feature in the source file. A tree-type file hierarchy will as a result automatically arise when the XML export is split into a plurality of files. There are several possibilities for distributing a (logically cohesive) object complex among a plurality of files:
Object-granular splitting: Subobjects belonging to an object are not embedded in the source file but are instead written to an external file.
Splitting at feature boundaries: Individual features are filed in separate files. This will be advantageous when, for instance, an application files its data in separate features substantially only of relevance to that application but not to others. If these are situated in a separate file, then the application will only need to read that file.

A file containing relocated objects is no different in structure from other files in which objects are filed. Each XML file starts with a standard header for identifying that this XML file belongs to a set of export files containing the filed object complex.

There are additional advantages in explicitly co-indicating the hierarchical dependencies between the files when exporting an object complex. This is not necessary, however, and only offers additional benefit through allowing any file in the export operation to be used as the entry point for processing. It offers simple navigation at file level for reaching the root element or, as the case may be, the direct (logical) parent element of the file from any file. For this purpose a standard header is defined for the structure of an (export) data file (such as <Document>). Two optional ‘parent’ and ‘root’ attributes can be provided in this header. ‘Parent’ indicates the next higher file in the hierarchy and ‘root’ directly indicates the root, which is to say the top element in the hierarchy. If both these attributes are used it will be possible from any file within an export to reach the root of the export or, as the case may be, the file by which the object data of the current file is referenced.

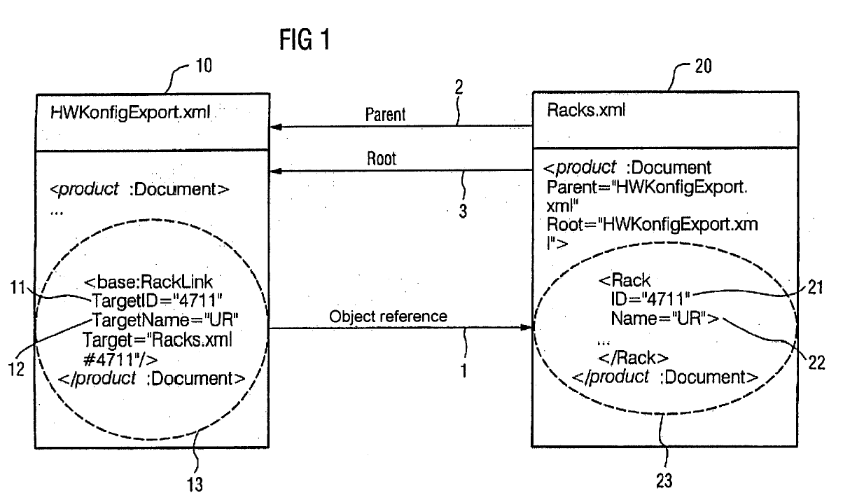

The structure of the header and of the entire XML file can be specified via an XML schema. Below is an example of an instance of an export file (see also FIG. 1).

Specimen file Racks.xml 20:

```
<Document
xmlns:base=“http://www.siemens.com/Industry/2001/Automation/Base”
    ...
    Parent=“HWKonfigExport.xml” Root=“HWKonfigExport.xml”>
  <FileInfo Version=“1.2”>
    ...
  </FileInfo>
</Document>
```

The file Racks.xml 20 is part of an XML export whose root is formed by the file HWKonfigExport.xml 10. This file 10 is at the same time the father node of Racks.xml 20 in the tree of the XML export. The parent relationship and root relationship are indicated in FIG. 1 by the arrow having the reference number 2 or, as the case may be, 3.

If an object is relocated along with its data to a separate file, a special reference 13 (ReferencePartOfT) will be required at the place where the object would “normally” be embedded. Said reference 13 indicates a case of relocating 23. The reference 13 here specifies which object has been relocated and in which file it can be found. The relationship between reference 13 on the one hand and relocating 23 on the other is indicated in FIG. 1 by an arrow having the reference number 1. Shown below is an example of how a schema definition of a relocation reference could look:

<xsd:complexType name=“ReferencePartOfT”>
<xsd:complexContent>

| | | |
|---|---|---|
| <xsd:attribute name=“Name” | type=“xsd:string” | use=“optional”/> |
| <xsd:attribute name=“Target” | type=“xsd:string” | use=“required”/> |

| | | |
|---|---|---|
| <xsd:attribute name=“TargetID” | type=“IdT” | use=“required”/> |

<xsd:attribute name=“TargetName”

| | |
|---|---|
| type=“xsd:string” | use=“required”/> |

</xsd:complexContent>
</xsd:complexType>

The attributes TargetID 11 and TargetName 12 contain the ID 21 and the name 22 of the relocated object to which the reference 13 points. The ID 21 is required for forming absolute references to the object from another place. The object can also be given a name 22 that can likewise be used for referencing. Even if an object is relocated, the name 22 or, as the case may be, the ID 21 will still be present on the main document owing to these two attributes TargetName 12 and TargetID 11. The advantage of this is that all cases of referencing to this object in the file can be navigated. This means that if the object's source file is read in/processed by an application, it will be possible to resolve references to the object and, if required, read the object from the relocated file.

Relocation references are very easy to use; the embedded object (the “rack” in the example) is simply replaced by a relocation reference (“RackLink” in the example). The element is defined in the product-specific schema as an element of the type product:ReferencePartOfT.

Example of using the relocation reference:

```
<base:Station ID=“1234” Name=“S7300”>
  <base:StructuralFeature>
    <base:RackLink TargetName=“UR”
        TargetID=“4711”
        Target=“../Drehen/Racks.xml#4711”/>
    </base:StructuralFeature>
</base:Station>
```

The definition of the relocation of the object (rack) can in this case be defined in the XML-schema for the source object as follows:

<xsd:element name=“RackLink” type=“ReferencePartOfT”/>

The relocating of individual features of an object results in there actually no longer being a complete object in the relocation file but instead only a part of the object. At the place in the source document where the feature would otherwise be filed there is only a link to the relocated feature. Example:

```
<SubSystem ID=“100” Name=“DP-Master”>
            <DisplayNameFeature>
    ...
            <DisplayNameFeature>
            <ProfibusFeatureLink
        Target=“Feature.xml#100/feature(ProfibusFeature)”/>
            ...
</SubSystem>
```

The actual feature is in the relocation file. So that it can be reassigned to an object, this feature is filed in a standard object wrapper (referred to also as an ObjectSurrogate). Example of the ProfibusFeature relocated in the above instance:

```
<ObjectSurrogate ID=“100” Name=“DP-Master”>
  <ProfibusFeature>
    <GROUP_IDENT_SUM_ALL_SLAVES Value=“255”/>
    <GROUP_SYNC_PROP Value=“255”/>
    <GROUP_FREEZE_PROP Value=“255”/>
    <LAST_USED_PROFIBUS_ADDR Value=“12”/>
    <Address Value=“12”/>
  </ProfibusFeature>
</ObjectSurrogate>
```

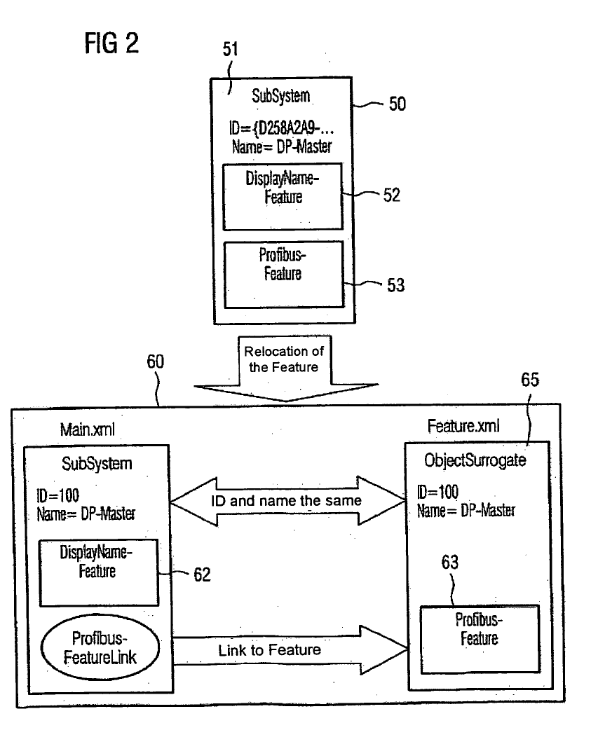

Said object wrapper (ObjectSurrogate) is a generic container for accommodating relocated features. It is not specific for the application object type whose data it contains. The object wrapper serves to establish the relevant context for the object part and contains the object's identification (ID and name). As can be seen in the instances given, the ID and name are respectively the same in the main file and the relocation file. FIG. 2 illustrates this correlation. The original situation has the reference number 50 if everything is filed in one file: The object SubSystem 51 has the two features DisplayNameFeature 52 and ProfibusFeature 53. The constellation in which the ProfibusFeature 63 has been relocated to a separate file 65 has the reference number 60. Below are examples of how definitions of the required types in the XML schema could look:

```
<xsd:complexType name=“ObjectSurrogateT”>
  <xsd:annotation>
      <xsd:documentation>object that contains features in partial
exports</xsd:documentation>
    </xsd:annotation>
    <xsd:complexContent>
      <xsd:restriction base=“ObjectT”>
          <xsd:sequence>
            <xsd:element name=“App_Id” type=
“ApplicationSpecificIdT” minOccurs =“0” maxOccurs=“unbounded”/>
            ...
            <xsd:element ref=“Feature” maxOccurs=“unbounded”/>
          </xsd:sequence>
        </xsd:restriction>
      </xsd:complexContent>
  </xsd:complexType>
<xsd:element name=“Feature” type=“FeatureT”/>
<xsd:element name=“ProfibusFeature” type=“ProfibusFeatureT”
substitutionGroup=“Feature”>
    <xsd:attribute name=“Name” type=“xsd:QName” use=“optional”/>
    <xsd:attribute name=“Target” type=“xsd:string” use=“required”/>
    <xsd:attribute name=“Type” type=“ReferenceTypeEnumT”
use=“optional” fixed=“PartOf”/>
</xsd:complexType>
```

The type of ProfibusFeature is derived from the basic type FeatureT. Because the SubstitutionGroup feature was specified for the element declaration, the element can be inserted in the ObjectSurrogate in place of Feature.

The handling of relocations can in a specific implementation be supported by a support library. This can automatically handle the distribution of the XML data among files both while the XML data is being read and during writing, and conceal the mechanism for users. From their perspective they are operating exclusively on the object model. Files and references are managed by the support library. This requires there to be appropriate schemas for the application data and for this to be used by the support library.

To summarize, the invention thus relates to a system and a method for the simplified management of data described by means of an extensible markup language wherein said data is structured in the form of objects, wherein components of said objects can be stored in first files, wherein said components each represent a logical unit of an object, and wherein a second file having first means for referencing said components is provided as a higher-order, object-based logical level for storing said objects.

1-6. (canceled)

7. A method for managing data described by an extensible markup language, the method comprising:
structuring the data in the form of objects, wherein components of the objects can be stored in first files, wherein the components each represent a logical unit of an object; and
providing a second file having a first mechanism for referencing the components as a higher-order, object-based logical level for storing the objects.

8. The method according to claim 7, wherein the components are themselves objects.

9. The method according to claim 7, wherein the components are stored in object-specific generic containers, and wherein the containers are provided for referencing the respective object.

10. The method according to claim 7, wherein the extensible markup language is XML.

11. A system for managing data described by an extensible markup language, wherein objects for structuring the data are provided, wherein components of the objects can be stored in first files, wherein the components each represent a logical unit of an object, and wherein a second file having first mechanisms for referencing the components is provided as a higher-order, object-based logical level for storing the objects.

12. The system according to claim 11, wherein the components are themselves objects.

13. The system according to claim 11, wherein object-specific generic containers are provided for storing the components of the objects, with said containers serving to reference the respective object.

14. The system according to claim 11, wherein the extensible markup language is XML.

15. A system for managing data described by an extensible markup language, the system comprising:
objects for structuring the data;
a first file for storing components of the objects, wherein the components each represent a logical unit of an object; and
a second file having a first mechanism for referencing the components as a superordinate, object-based logical level for storing the objects.

16. The system according to claim 15, wherein the components are themselves objects.

17. The system according to claim 15, wherein object-specific generic containers are provided for storing the components of the objects, wherein said containers serving to reference the respective object.

18. The system according to claim 15, wherein the extensible markup language is XML.
